(19) United States
(12) Patent Application Publication
(10) Pub. No.: US 2016/0133388 A1
(43) Pub. Date: May 12, 2016

(54) TANTALUM CAPACITOR AND METHOD OF MANUFACTURING THE SAME

(71) Applicant: SAMSUNG ELECTRO-MECHANICS CO., LTD., Suwon-Si (KR)

(72) Inventors: Wan Suk YANG, Suwon-Si (KR); Hong Kyu SHIN, Suwon-Si (KR); Kyoung Sup CHOI, Suwon-Si (KR)

(21) Appl. No.: 14/869,525

(22) Filed: Sep. 29, 2015

(30) Foreign Application Priority Data
Nov. 7, 2014 (KR) 10-2014-0154286

(51) Int. Cl. H01G 9/042; H01G 9/00; H01G 9/012; H01G 9/025; H01G 9/15

(52) U.S. Cl. CPC H01G 9/042; H01G 9/025; H01G 9/15; H01G 9/012; H01G 9/0036

(57) ABSTRACT

A tantalum capacitor includes a capacitor body; a tantalum wire disposed on a surface of the capacitor body; an encapsulant part enclosing the capacitor body and the tantalum wire; an anode lead frame connected to the tantalum wire and exposed to an outer surface of the encapsulant part; and a cathode lead frame disposed on a surface of the capacitor body and exposed to the outer surface of the encapsulant part. The anode lead frame includes a plating part connected to the tantalum wire and an electrode plate connected to the plating part and exposed to the outer surface of the encapsulant part.

### CROSS-REFERENCE TO RELATED APPLICATION

This application claims the benefit of priority to Korean Patent Application No. 10-2014-0154286, filed on Nov. 7, 2014 with the Korean Intellectual Property Office, the entirety of which is incorporated herein by reference.

### BACKGROUND

The present disclosure relates to a tantalum capacitor and a method of manufacturing the same.

Tantalum (Ta) is a metal widely used throughout various industrial sectors, such as the aerospace industry and the defense sector, as well as in the electrical, electronic, mechanical, and chemical engineering fields, because it has desirable mechanical and physical properties such as a high melting point, excellent flexibility, excellent corrosion-resistance, and the like.

Since tantalum can form a stable anodized oxide film, tantalum has been widely used as a material in forming positive electrodes for small capacitors. In accordance with the rapid development of information technology (IT), information and communications technology (ICT) and electronics technology, the use of tantalum has increased 10% on a year-on-year basis.

Generally, a capacitor is a condenser temporarily storing electricity therein, and is a component in which two flat plate electrodes, disposed in close proximity to each other, are insulated from each other with a dielectric substance inserted therebetween, and may be charged with an electric charge due to attractive force, thereby allowing electricity to be accumulated therein. Such a capacitor stores electric charges and electric fields in a space enclosed by two conductors, and is commonly used to acquire capacitance.

A tantalum capacitor containing a tantalum material has a structure in which voids are formed at the time of sintering and curing tantalum powder. It is completed by first forming tantalum oxide (Ta₂O₅) on a tantalum surface using an anodic oxidation method, and then forming a polymer layer and a manganese dioxide (MnO₂) layer, an electrolyte, on the tantalum oxide layer acting as a dielectric substance. Then, a carbon layer and a metal layer are formed on the manganese dioxide layer and the polymer layer to form a body, an anode lead frame and a cathode lead frame are formed on the body for mounting on a printed circuit board (PCB), and an encapsulant part is formed.

In order to connect a tantalum wire of the tantalum capacitor to an electrode of the board on which the tantalum capacitor is mounted, the tantalum wire should be connected to the anode lead frame. Here, a part designed to bond the anode lead frame and the tantalum wire to each other is called a stand part, and it is manufactured by welding the electrode to the anode leadframe. With the contemporary miniaturization of the tantalum capacitor, the defect rate occurring from the welding process have increased, as have the costs required for manufacturing the tantalum capacitor.

### SUMMARY

One aspect of the present disclosure may provide a tantalum capacitor having a decreased defect rate and improved characteristics, being manufactured at a reduced cost, and being miniaturized by forming an anode lead frame without performing a welding process and forming the anode lead frame and cathode lead frame integrally with each other to simplify the manufacturing process.

According to one aspect of the present disclosure, a tantalum capacitor comprises a capacitor body; a tantalum wire disposed on a surface of the capacitor body; an encapsulant part enclosing the capacitor body and the tantalum wire; an anode lead frame connected to the tantalum wire and exposed to an outer surface of the encapsulant part; and a cathode lead frame disposed on a surface of the capacitor body and exposed to the outer surface of the encapsulant part, wherein the anode lead frame includes a plating part connected to the tantalum wire and an electrode plate connected to the plating part and exposed to the outer surface of the encapsulant part.

The plating part may be connected integrally with the electrode plate.

The plating part may contain at least one of nickel and copper.

The plating part may have a quadrangular pillar shape.

The plating part may have inclined side surfaces.

The side surfaces of the electrode plate and the cathode lead frame may be cut surfaces.

The thickest portion of the electrode plate and a thickest portion of the cathode lead frame may have the same thickness.

The anode lead frame and the cathode lead frame may be exposed to a lower surface of the tantalum capacitor.

According to another aspect of the present disclosure, a method of manufacturing a tantalum capacitor, comprises steps of: preparing a conductive sheet; forming an anode lead frame and a cathode lead frame by cutting and compressing the conductive sheet; forming a plating part on a surface of the anode lead frame by an electroforming method; mounting a capacitor body on the anode lead frame and the cathode lead frame, the capacitor body having a tantalum wire disposed on a surface of the capacitor body; and forming an encapsulant part to enclose the capacitor body and the tantalum wire and externally expose surfaces of the anode lead frame and the cathode lead frame.

In the step of forming the anode lead frame and the cathode lead frame by cutting and compressing the conductive sheet, the anode lead frame and the cathode lead frame may be simultaneously formed in a single process.

The step of forming the plating part on a surface of the anode lead frame by the electroforming method may comprise manufacturing a mold for performing the electroforming method; forming an electroforming seed layer; immersing the anode lead frame in an electrolyte for electroforming; and removing the mold.

The step of mounting the capacitor body on the anode lead frame and the cathode lead frame may comprise bonding the plating part to the tantalum wire.

The step of mounting the capacitor body on the anode lead frame and the cathode lead frame may further comprise etching a portion of the plating part connected to the tantalum wire before bonding the plating part to the tantalum wire.

The step of mounting the capacitor body on the anode lead frame and the cathode lead frame may further comprise disposing a conductive adhesive between the cathode lead frame and the capacitor body.

### BRIEF DESCRIPTION OF DRAWINGS

The above and other aspects, features and advantages of the present disclosure will be more clearly understood from the following detailed description taken in conjunction with the accompanying drawings.

FIG. 1 is a perspective view of a tantalum capacitor according to an exemplary embodiment in the present disclosure.

FIG. 2 is a cross-sectional view of the tantalum capacitor taken along line A-A′ of FIG. 1.

FIGS. 3A through 3G are views of a method of manufacturing a tantalum capacitor according to an exemplary embodiment.

FIG. 4 is a flow chart illustrating the method of manufacturing a tantalum capacitor according to an exemplary embodiment.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Tantalum Capacitor

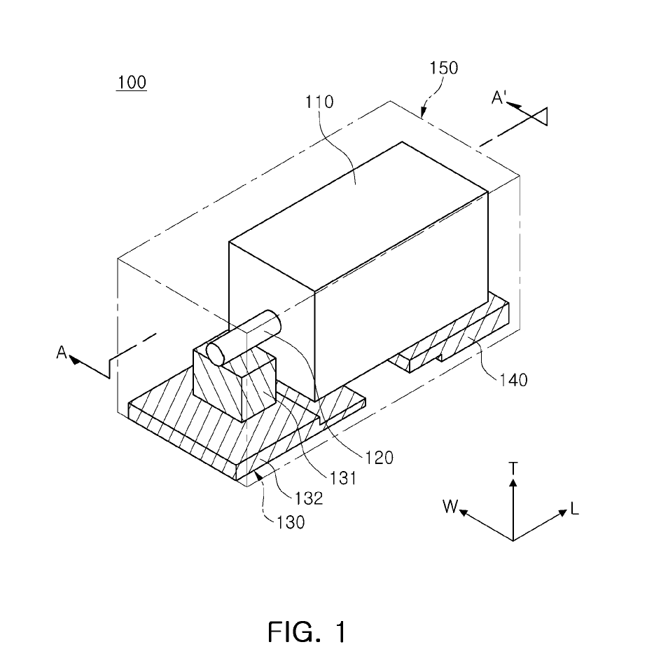

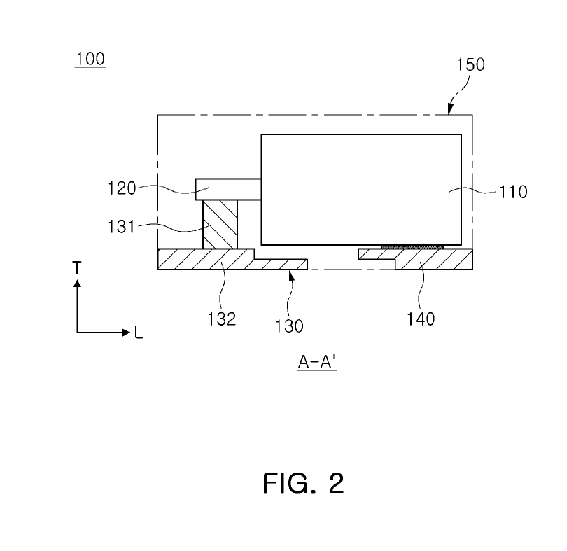

FIG. 1 is a perspective view of a tantalum capacitor 100 according to an exemplary embodiment in the present disclosure; and FIG. 2 is a cross-sectional view of the tantalum capacitor 100 taken along line A-A′ of FIG. 1. In FIGS. 1 and 2, a length direction L, a width direction W, and a thickness direction T of the tantalum capacitor 100 are defined. Therefore, the tantalum capacitor 100 according to an exemplary embodiment will be described.

Referring to FIGS. 1 and 2, the tantalum capacitor 100 may include a capacitor body 110, a tantalum wire 120 disposed on one surface of the capacitor body 110, an encapsulant part 150 disposed to enclose the capacitor body 110 and the tantalum wire 120, an anode lead frame 130 connected to the tantalum wire 120 and exposed to one surface of the encapsulant part 150, and a cathode lead frame 140 disposed on one surface of the capacitor body 110 and exposed to one surface of the encapsulant part 150. Here, the anode lead frame 130 may include a plating part 131 connected to the tantalum wire 120 and an electrode plate 132 connected to the plating part 131 and exposed to one surface of the encapsulant part 150.

The capacitor body 110 may be formed of tantalum. As an example, the capacitor body 110 may be manufactured by mixing tantalum powder and a binder at a predetermined ratio, agitating the mixture of the tantalum powder and the binder, compressing the mixed powder of the tantalum powder and the binder to form a rectangular parallelepiped, and sintering the rectangular parallelepiped at a high temperature and with high vibrations.

The tantalum wire 120 may be disposed on one surface of the capacitor body 110. Referring to FIGS. 1 and 2, the tantalum wire 120 may be disposed on one end surface of the capacitor body 110 in the length direction. However, a position of the tantalum wire 120 is not limited thereto.

The tantalum wire 120 may be inserted into and mounted in the mixtures of the tantalum powder and the binder before the mixed powders of the tantalum powder and the binder are compressed. For instance, the capacitor body 110 may be manufactured by inserting the tantalum wire 120 into the tantalum powder with which the binder is mixed, forming a tantalum element having a desired size, and then sintering the tantalum element at a temperature of about 1,000° C. to 2,000° C. under a high-vacuum atmosphere (10⁻⁵ torr or less) for about 30 minutes.

The tantalum wire 120 may be connected to the anode lead frame 130. The anode lead frame 130 may include the plating part 131 connected to the tantalum wire 120 and the electrode plate 132 connected to the plating part 131 and externally exposed from the encapsulant part 150. The electrode plate 132 may be connected to an external power supply to allow for current flow to the tantalum wire 120 through the plating part 131. For instance, the anode lead frame 130 may be exposed to one surface of the encapsulant part 150 and be used as a connection terminal for electrical connection to another electronic product. To this end, the anode lead frame 130 may be formed of a conductive metal such as a nickel-iron alloy, or the like.

The capacitor body 110 may be connected to the cathode lead frame 140. The cathode lead frame 140 may be spaced apart from the anode lead frame 130 and the tantalum wire 120. The cathode lead frame 140 may be partially externally exposed from the encapsulant part 150 and be used as a connection terminal for electrical connection to another electronic product. The cathode lead frame 140 may be formed of a conductive metal such as a nickel-iron alloy, or the like. The anode lead frame 130 and the cathode lead frame 140 may be disposed in parallel with each other to be spaced apart from each other.

Referring to FIGS. 1 and 2, the anode lead frame 130 and the cathode lead frame 140 may be disposed on a lower surface of the capacitor body 110 and be disposed to be exposed to a lower surface of the tantalum capacitor 100.

When the anode lead frame and the cathode lead frame are exposed to side surfaces of the tantalum capacitor, the anode lead frame and the cathode lead frame need to be bent in order to form electrodes. Therefore, regions occupied by the anode lead frame and the cathode lead frame within the encapsulant part 150 may be large, such that a region occupied by the capacitor body may become relatively small. As a result, capacitance of the tantalum capacitor may be decreased.

Conversely, in a case in which the anode lead frame and the cathode lead frame are disposed on the lower surface of the tantalum capacitor, regions occupied by the anode lead frame and the cathode lead frame within the encapsulant part 150 may become small, such that the region occupied by the capacitor body may be large. Therefore, the tantalum capacitor having a high capacitance may be manufactured.

The anode lead frame 130 may include the plating part 131. Since the tantalum wire 120 is disposed to protrude on aside surface of the capacitor body 110, the tantalum wire 120 may be disposed to be spaced apart from an outer surface of the tantalum capacitor 100 by a predetermined distance. Therefore, the anode lead frame 130 may require a component (hereinafter, referred to as a stand part) serving to connect the anode lead frame 130 to the tantalum wire 120 while being exposed to the outer surface of the tantalum capacitor 100. In the present disclosure, the plating part 131 may perform the above-mentioned role.

An anode lead frame of a tantalum capacitor, according to the related art, may be generally formed by cutting and compressing a conductive sheet to form an electrode plate and bonding a separately manufactured stand part onto an upper surface of the electrode plate by a separate welding process. Because a separate welding process is performed, the manufacturing process may be more complicated, and manufacturing costs may be high. In addition, the anode lead frame of the tantalum capacitor, according to the related art, has a range of problems. First, it is difficult to accurately fix the stand part to a specific position on the upper surface of the electrode plate for the purpose of welding. Second, short circuits may be generated due to application of a welding material, or the like. Third, the stand part may be welded in a state in which it is inclined due to the welding material, or the like. Fourth, since the stand part needs to be miniaturized in accordance with miniaturization of the tantalum capacitor, it is difficult to bond the miniaturized stand part by the welding process.

In the anode lead frame 130 of the tantalum capacitor 100 according to an exemplary embodiment, the plating part 131 may be formed by an electroforming method. Since the plating part 131 is connected integrally with the electrode plate 132 of the anode lead frame 130 by the electroforming method, a separate welding process may not be required. Therefore, a manufacturing process may be simple, and manufacturing costs may be reduced. In addition, defects due to the welding process described above may not be generated, and a tantalum capacitor 100 having a small size may be manufactured.

The conductive sheet, which is a material forming the anode lead frame 130 and the cathode lead frame 140, may be formed of a conductive metal such as a nickel-iron alloy, or the like. The conductive sheet may be cut and compressed to form the anode lead frame 130 and the cathode lead frame 140 having a desired size and form. Therefore, side surfaces of the electrode plate 132 and the cathode lead frame 140 may be cut surfaces.

The plating part 131 may be formed on one surface of the cut and compressed anode lead frame 130 by the electroforming method. The plating part 131 may contain at least one of nickel and copper. A mold for forming the plating part 131 may be formed on one surface of the anode lead frame 130, and an electroforming seed layer may be formed in a region in which the plating part 131 is to be formed. The electroforming seed layer may contain any one of nickel and copper. When the electroforming method is performed on the anode lead frame 130 on which the electroforming seed layer is formed, the plating part 131 may be formed from the electroforming seed layer along the mold.

A shape and a size of the plating part 131 may be modified, if necessary. Although a case in which the plating part 131 has a quadrangular pillar shape has been illustrated in FIGS. 1 and 2, the plating part 131 is not limited thereto, and may have a cylindrical shape. In addition, since the plating part 131 is formed by the electroforming method, the plating part 131 may be gradually formed from the electroforming seed layer, such that a cross-sectional area of the plating part 131 may become narrow from the electroforming seed layer toward an upper portion of the plating part 131. In this case, the plating part 131 may have side surfaces inclined from the upper portion thereof to a lower portion thereof, and have a shape such as a quadrangular pyramid shape, a conical shape, or the like, depending on shapes of the mold and the electroforming seed layer.

In other words, a cross-sectional area of an upper surface of the plating part 131, which is a portion of the plating part 131 connected to the tantalum wire 120, may be wider than that of a lower surface of the plating part 131, which is a portion of the plating part 131 connected to the electrode plate 132. Therefore, the plating part 131 may have a width that becomes narrow from the upper portion thereof toward the lower portion thereof, such that the side surfaces of the plating part 131 may be inclined.

Since the electrode plate 132 of the anode lead frame 130 and the cathode lead frame 140 are formed by compressing and cutting the same conductive sheet, thicknesses of the electrode plate 132 of the anode lead frame 130 and the cathode lead frame 140 may be identical. For instance, a thickness of the thickest portion of the electrode plate 132 and a thickness of the thickest portion of the cathode lead frame 140 may be identical.

The tantalum capacitor 100, according to an exemplary embodiment, may further include an adhesive in order to bond the cathode lead frame 140 and the capacitor body 110 to each other. The adhesive disposed between the cathode lead frame 140 and the capacitor body 110 may be an adhesive containing an epoxy-based thermosetting resin. However, the adhesive, according to the present disclosure, is not limited thereto.

The capacitor body 110 and the tantalum wire 120 may be enclosed by the encapsulant part 150. Partial regions of the plating part 131 and the electrode plate 132 of the anode lead frame 130 and a partial region of the cathode lead frame 140 may also be positioned in the encapsulant part 150. Some surfaces of the electrode plate 132 of the anode lead frame 130 and the cathode lead frame 140 may be externally exposed from the encapsulant part 150.

The encapsulant part 150 may be formed by transfer-molding a resin such as an epoxy molding compound (EMC), or the like.

The encapsulant part 150 may not only serve to protect the tantalum wire 120 and the capacitor body 110 from external factors, but may also serve to insulate the capacitor body 110 and the anode lead frame 130 from each other.

Method of Manufacturing Tantalum Capacitor

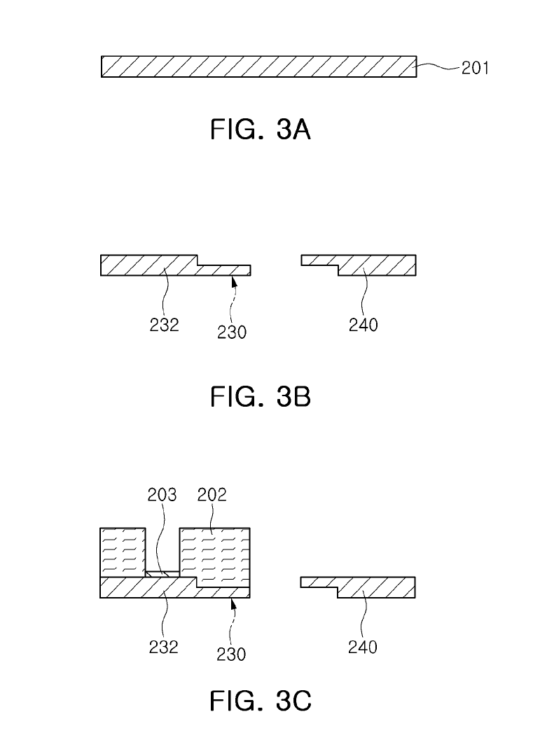

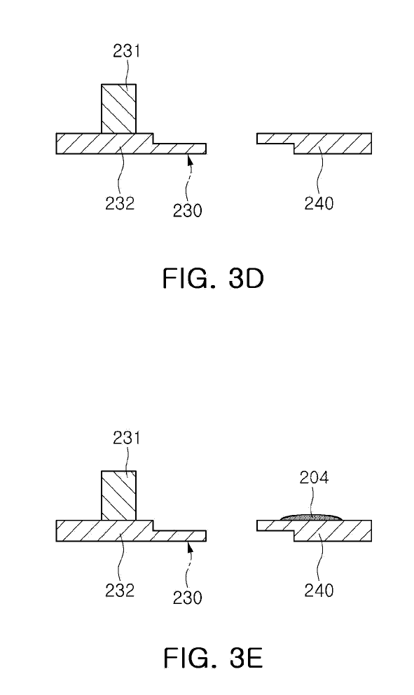

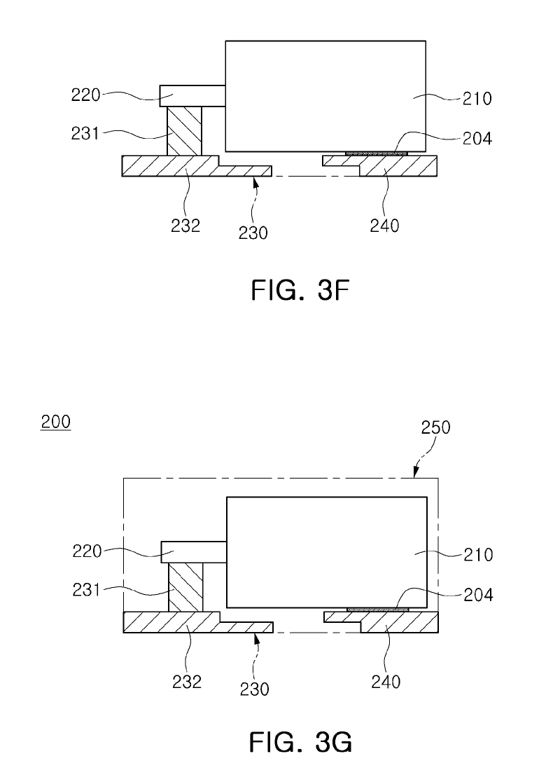

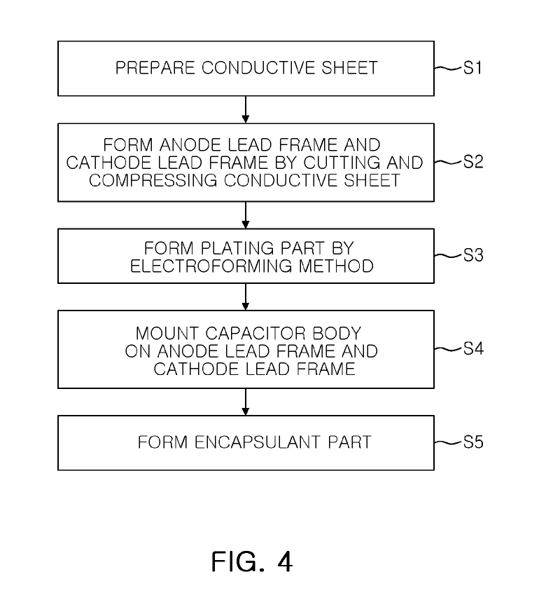

FIGS. 3A through 3G are views of a method of manufacturing a tantalum capacitor 200 according to an exemplary embodiment; and FIG. 4 is a flow chart illustrating the method of manufacturing a tantalum capacitor 200 according to an exemplary embodiment.

Referring to FIGS. 3A through 3G, the method of manufacturing a tantalum capacitor 200, according to an exemplary embodiment, may include preparing a conductive sheet 201 (S1), forming an anode lead frame 230 and a cathode lead frame 240 by cutting and compressing the conductive sheet 201 (S2), forming a plating part 231 on one surface of the anode lead frame 230 by an electroforming method (S3), mounting a capacitor body 210 on upper surfaces of the anode lead frame 230 and the cathode lead frame 240 (S4), the capacitor body 210 having a tantalum wire 220 disposed on one surface thereof, and forming an encapsulant part 250 to enclose the capacitor body 210 and the tantalum wire 220 and externally expose one surface of each the anode lead frame 230 and the cathode lead frame 240 (S5).

FIG. 3A illustrates the conductive sheet 201, which is a material for manufacturing the anode lead frame 230 and the cathode lead frame 240. The conductive sheet 201 may be formed of a conductive metal such as a nickel-iron alloy, or the like.

Next, as illustrated in FIG. 3B, an electrode plate 232 of the anode lead frame 230 and the cathode lead frame 240 may be formed by cutting and compressing the conductive sheet 201 (S2). Then electrode plate 232 of the anode lead frame 230 and the cathode lead frame 240 may be cut to an appropriate length in consideration of a size of the capacitor body 210 that is to be mounted thereon and a size of the tantalum capacitor 200. In addition, a special shape may be compressed and formed on mounted surfaces of the electrode plate 232 of the anode lead frame 230 and the cathode lead frame 240 in order to increase adhesion strength between the anode lead frame 230 and the cathode lead frame 240 and the capacitor body 210, and grooves may be formed in the anode lead frame 230 and the cathode lead frame 240 in order to improve strength of the anode lead frame 230 and the cathode lead frame 240. The cutting and compressing processes may be simultaneously performed to form the electrode plate 232 of the anode lead frame 230 and the cathode lead frame 240. Therefore, the processes may be simple, and manufacturing costs may be reduced.

Next, the plating part 231 may be formed on one surface of the electrode plate 232 of the anode lead frame 230 by an electroforming method (S3). In the electroforming method, a mold may be formed using photolithography technology.

A photosensitive photoresist may be applied onto one surface of the electrode plate 232, and a photo mask having a shape corresponding to a shape of the plating part 231 that is to be formed may be aligned on the electrode plate 232. When an exposing process and a developing process are performed on the electrode plate 232 onto which the photosensitive photoresist is applied and on which the photo mask is aligned, the photosensitive photoresist may remain in a region except for a region in which the plating part 231 is to be formed on the electrode plate 232. The remaining photosensitive photoresist may become a mold 202 for forming the plating part 231.

FIG. 3C illustrates the mold 202 and a seed layer 203. The seed layer 203 may be formed in a region in which the plating part 231 of the anode lead frame 230 on which the mold 202 is formed is to be formed. Then, when the anode lead frame 230 is immersed in an electrolyte for electroforming, the plating part 231 may be formed along the seed layer 203. Then, when the mold 202 is removed from the anode lead frame 230 on which the plating part 231 is formed, the anode lead frame 230 including the plating part 231 may be formed (See FIG. 3D).

Next, the capacitor body 210 having the tantalum wire 220 disposed on one surface thereof may be mounted on the upper surfaces of the anode lead frame 230 and the cathode lead frame 240 (S4). The anode lead frame 230 and the cathode lead frame 240 may be disposed in parallel with each other to face each other. Here, heat-resistant tape may be attached onto lower surfaces of the anode lead frame 230 and the cathode lead frame 240 to be connected to each other. The heat-resistant tape may prevent surfaces of the anode lead frame 230 and the cathode lead frame 240 from being polluted in a molding process that is later performed.

Next, in a state in which the capacitor body 210 is mounted on an upper surface of a front end portion of the cathode lead frame 240 and the tantalum wire 220 of the capacitor body 210 contacts the plating part 231 of the anode lead frame 230, the tantalum wire 220 and the plating part 231 may be electrically attached to each other by performing spot-welding, laser-welding, or by applying a conductive adhesive. Here, as illustrated in FIG. 3E, before the capacitor body 210 is mounted, the conductive adhesive 204 may be applied to a mounted part of the cathode lead frame 240 to form a conductive adhesive layer 204 having a predetermined thickness, thereby improving adhesion strength between the cathode lead frame 240 and the capacitor body 210. Then, a process of hardening the conductive adhesive layer 204 at a temperature of about 100° C. to 200° C. may be performed. FIG. 3F illustrates a shape in which the capacitor body 210 is mounted on the anode lead frame 230 and the cathode lead frame 240.

The mounting of the capacitor body 210 on the upper surfaces of the anode lead frame 230 and the cathode lead frame 240 may further include, before bonding the plating part 231 to the tantalum wire 220 disposed on one surface of the capacitor body 210 to be connected to the tantalum wire 220, etching a portion of the plating part 231 connected to the tantalum wire 220.

In order to stably mount the tantalum wire 220 on the plating part 231, an upper surface of the plating part 231 may be etched in a shape corresponding to that of the tantalum wire 220 to increase a bonding surface between the tantalum wire 220 and the plating part 231. Therefore, the tantalum wire 220 may be more stably mounted on the plating part 231, and conductivity may be increased, such that electrical characteristics such as an equivalent series resistance (ESR), an equivalent series inductance (ESL), and the like, may be improved.

Next, as illustrated in FIG. 3G, the encapsulant part 250 may be formed to enclose the capacitor body 210 and the tantalum wire 220 and externally expose one surface of each the anode lead frame 230 and the cathode lead frame 240 (S5). The encapsulant part 250 may serve to protect the tantalum wire 220 and the capacitor body 210 from external factors.

When a shape of the encapsulant part 250 is completed, the heat-resistant tape attached to the lower surfaces of the anode lead frame 230 and the cathode lead frame 240 may be removed.

The tantalum capacitor 200, according to an exemplary embodiment, may be manufactured through the above-mentioned process.

As set forth above, in the tantalum capacitor, according to exemplary embodiments, the anode lead frame is formed without performing a welding process, and the anode lead frame and the cathode lead frame are formed integrally with each other to simplify a manufacturing process, whereby a defect rate may be decreased, product characteristics may be improved, manufacturing costs may be reduced, and a product may be miniaturized.

While exemplary embodiments have been shown and described above, it will be apparent to those skilled in the art that modifications and variations could be made without departing from the scope of the present invention as defined by the appended claims.

What is claimed is:

1. A tantalum capacitor comprising:
a capacitor body;
a tantalum wire disposed on a surface of the capacitor body;
an encapsulant part enclosing the capacitor body and the tantalum wire;
an anode lead frame connected to the tantalum wire and exposed to an outer surface of the encapsulant part; and
a cathode lead frame disposed on a surface of the capacitor body and exposed to the outer surface of the encapsulant part,
wherein the anode lead frame includes a plating part connected to the tantalum wire and an electrode plate connected to the plating part and exposed to the outer surface of the encapsulant part.

2. The tantalum capacitor of claim 1, wherein the plating part is connected integrally with the electrode plate.

3. The tantalum capacitor of claim 1, wherein the plating part contains at least one of nickel and copper.

4. The tantalum capacitor of claim 1, wherein the plating part has a quadrangular pillar shape.

5. The tantalum capacitor of claim 1, wherein the plating part has inclined side surfaces.

6. The tantalum capacitor of claim 1, wherein side surfaces of the electrode plate and the cathode lead frame are cut surfaces.

7. The tantalum capacitor of claim 1, wherein a thickest portion of the electrode plate a thickest portion of the cathode lead frame may have the same thickness.

8. The tantalum capacitor of claim 1, wherein the anode lead frame and the cathode lead frame are exposed to a lower surface of the tantalum capacitor.

9. A method of manufacturing a tantalum capacitor, comprising steps of:
preparing a conductive sheet;
forming an anode lead frame and a cathode lead frame by cutting and compressing the conductive sheet;
forming a plating part on a surface of the anode lead frame by an electroforming method;
mounting a capacitor body on the anode lead frame and the cathode lead frame, the capacitor body having a tantalum wire disposed on a surface of the capacitor body; and
forming an encapsulant part to enclose the capacitor body and the tantalum wire and externally expose surfaces of the anode lead frame and the cathode lead frame.

10. The method of manufacturing a tantalum capacitor of claim 9, wherein in the step of forming the anode lead frame and the cathode lead frame by cutting and compressing the conductive sheet, the anode lead frame and the cathode lead frame are simultaneously formed in a single process.

11. The method of manufacturing a tantalum capacitor of claim 9, wherein the step of forming the plating part on a surface of the anode lead frame by the electroforming method comprises:
manufacturing a mold for performing the electroforming method;
forming an electroforming seed layer;
immersing the anode lead frame in an electrolyte for electroforming; and
removing the mold.

12. The method of manufacturing a tantalum capacitor of claim 9, wherein the step of mounting the capacitor body on the anode lead frame and the cathode lead frame comprises bonding the plating part to the tantalum wire.

13. The method of manufacturing a tantalum capacitor of claim 12, wherein the step of mounting the capacitor body on the anode lead frame and the cathode lead frame further comprises etching a portion of the plating part connected to the tantalum wire before bonding the plating part to the tantalum wire.

14. The method of manufacturing a tantalum capacitor of claim 9, wherein the step of mounting the capacitor body on the anode lead frame and the cathode lead frame further comprises disposing a conductive adhesive between the cathode lead frame and the capacitor body.
